(19) United States
(12) Patent Application Publication
(10) Pub. No.: US 2025/0344893 A1
(43) Pub. Date: Nov. 13, 2025

(54) Food Steamer

(71) Applicant: Tommy Songfong Wang, City of Industry, CA (US)

(72) Inventor: Tommy Songfong Wang, City of Industry, CA (US)

(21) Appl. No.: 18/657,440

(22) Filed: May 7, 2024

(51) Int. Cl. A47J 27/04; H05B 6/12

(52) U.S. Cl. CPC A47J 27/04; H05B 6/1263; A47J 2027/043

(57) ABSTRACT

A food steamer includes a multi-zone induction cooker, a steamer and a user control panel. The steamer is disposed on the multi-zone induction cooker. The multi-zone induction cooker includes a plurality of heating coils and a heating control circuit. The plurality of heating coils are arranged side-by-side. The heating control circuit is electrically coupled to the heating coils. The steamer includes a top tray and a plurality of water tanks. The top tray has a plurality of steam holes. Each of the plurality of water tanks is separated from the other and disposed above each of the heating coils. The user control panel is electrically coupled to the heating control circuit. The user control panel can generate temperature requests. The heating control circuit can respectively regulate a power of each of the heating coils according to the temperature requests.

### FIELD OF THE INVENTION

The present invention generally relates to a steamer and, more particularly, to a food steamer.

### BACKGROUND OF THE INVENTION

Some foods, such as dim sum, are usually cooked and heated in the steamers in the kitchen and served to the customer on a plate upon request. Then, after a short period of time, the food begins to become cold and dry, which may affect the customer's enjoyment of the food.

However, traditional steamers are stationary in the kitchen and cannot be brought to the table for customers to maintain the food in a warm and moist state during dining.

### SUMMARY OF THE INVENTION

In order to overcome the disadvantages associated with the aforementioned steamers, a food steamer is disclosed. In one aspect, the food steamer includes a multi-zone induction cooker, a steamer and a user control panel. The steamer is disposed on the multi-zone induction cooker. The multi-zone induction cooker includes a plurality of heating coils and a heating control circuit. The plurality of heating coils is arranged side-by-side. The heating control circuit is electrically coupled to the heating coils. The steamer includes a top tray and a plurality of water tanks. The top tray has a plurality of steam holes. Each of the water tanks is separated from the other and disposed above each of the heating coils. The user control panel is electrically coupled to the heating control circuit. The user control panel can generate temperature requests. The heating control circuit can respectively regulate a power of each of the heating coils according to the temperature requests.

The food steamer may be configured such that the steamer further includes a partition that vertically intersects the top ray and is aligned with a boundary between the water tanks.

The food steamer may be configured such that the multi-zone induction cooker further includes a plurality of cooling fans and a cooling control circuit. Each of the plurality of cooling fans are separated from the other and disposed beneath each of the heating coils. The cooling control circuit is electrically coupled to the cooling fans. The cooling control circuit can respectively regulate a power of each of the cooling fans according to the temperature requests.

The food steamer may be configured such that the steamer further includes a water level sensor. The water level sensor is in each of the water tanks. The water level sensor can trigger an alarm when a water level in each of the water tanks is insufficient.

The food steamer may be configured such that the plurality of the water tanks includes three rectangular pots.

The food steamer may be configured such that the plurality of the water tanks includes two semicircular pots.

The food steamer may be configured such that each of the water tanks further includes a drain port.

The food steamer may be configured such that each of the water tanks further includes an inlet port.

In another aspect, the food steamer includes a multi-zone induction cooker, a steamer and a user control panel. The steamer is disposed on the multi-zone induction cooker. The multi-zone induction cooker includes a plurality of heating coils and a heating control circuit. The plurality of heating coils is arranged side-by-side. The heating control circuit is electrically coupled to the heating coils. The steamer includes a top tray, a plurality of water tanks, a plurality of sliding covers, and a plurality of driving devices. The top tray has a plurality of steam holes. Each of the water tanks is separated from the other and disposed above each of the heating coils. The sliding covers are located beneath the top tray and aligned with the water tanks. The driving devices are connected to the sliding covers. The user control panel is electrically coupled to the heating control circuit and the driving devices. The user control panel can generate temperature requests and zone requests. The heating control circuit can respectively regulate a power of each of the heating coils according to the temperature requests. The driving device can control a movement of the sliding cover to selectively open or block the steam holes of the top tray according to the zone requests.

### BRIEF DESCRIPTION OF THE DRAWINGS

The drawings illustrate examples. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 shows a perspective view of an embodiment of a food steamer, including a multi-zone induction cooker, a steamer and a user control panel.

FIG. 2 shows an exploded schematic diagram of the embodiment shown in FIG. 1.

FIG. 3 shows an exploded schematic diagram of a steamer of an embodiment.

FIG. 4 shows a schematic diagram of a multi-zone induction cooker of an embodiment.

FIG. 5 shows a schematic diagram of a steamer of another embodiment of a food steamer.

FIG. 6 shows a top view of a steamer of yet another embodiment of a food steamer.

### DETAILED DESCRIPTION OF THE PREFERRED EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

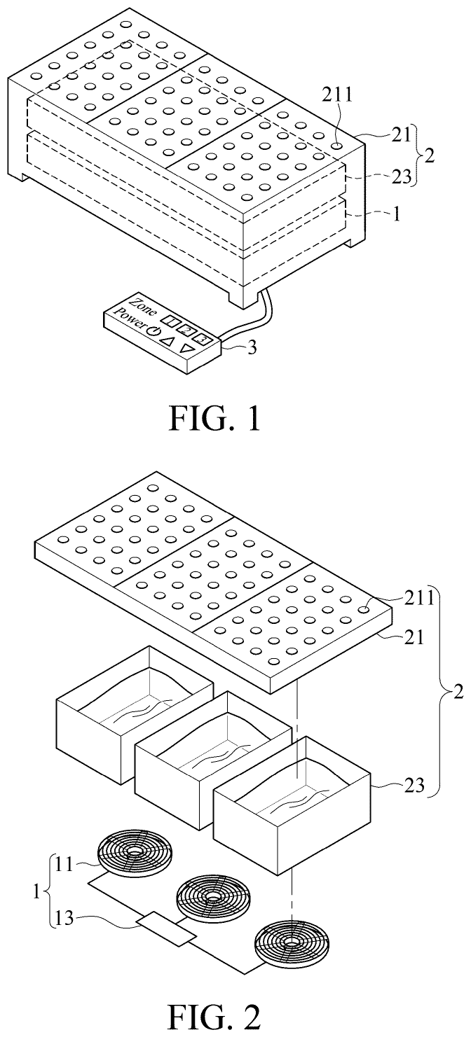

FIG. 1 shows a perspective view of an embodiment of a food steamer, including a multi-zone induction cooker, a steamer and a user control panel. FIG. 2 shows an exploded schematic diagram of the embodiment shown in FIG. 1.

Referring to FIGS. 1 to 2 together, the food steamer includes a multi-zone induction cooker 1, a steamer 2 and a user control panel 3. The steamer 2 is disposed on the multi-zone induction cooker 1.

The multi-zone induction cooker 1 includes a plurality of heating coils 11 and a heating control circuit 13. The heating control circuit 13 is electrically coupled to the heating coils 11. The heating coils 11 are arranged side-by-side. In one example, the heating coils 11 are on the same level and face upward. It is noted that the size and shape of each heating coil 11 may vary according to the needs of the steamer 2.

The steamer 2 includes a top tray 21 and a plurality of water tanks 23. The top tray 21 is disposed on the plurality of water tanks 23. The top tray 21 can hold dim sum or food that requires to be kept warm. The top tray 21 has a plurality of steam holes 211. Each of the water tanks 23 is separated from the other and disposed above each of the heating coils 11. Consequently, each heating coil 11 can heat the water within each tank 23 to generate water vapor. Then, the water vapor propagates through the steam holes 211 to reach the food on the top tray 21, thereby keeping the food in a warm and moist state during dining.

The user control panel 3 is electrically coupled to the heating control circuit 13. The user control panel 3 can generate temperature requests by user operation. In one example, the user control panel 3 is, but not limited to, a touch panel. It includes a plurality of selections of temperature control zones, which are defined by the heating coils 11. In one embodiment, there are three heating coils 11 arranged on the same level and correspondingly defining three temperature control zones. The user control panel 3 can generate a temperature request to heat any one of the three zones, such as left, center, right, based on the user's request. This allows the food steamer to avoid unnecessary heating and steam production, resulting in energy and water savings.

Furthermore, the heating control circuit 13 can respectively regulate a power of each of the heating coils 11 according to the temperature requests. In one embodiment, the user can turn the heating coils 11 on or off from the user control panel 3 and select a desired temperature level (i.e., the power level of the heating coils), such as high or low. Thus, the user can control the temperature level based on the type of food or personal eating preferences.

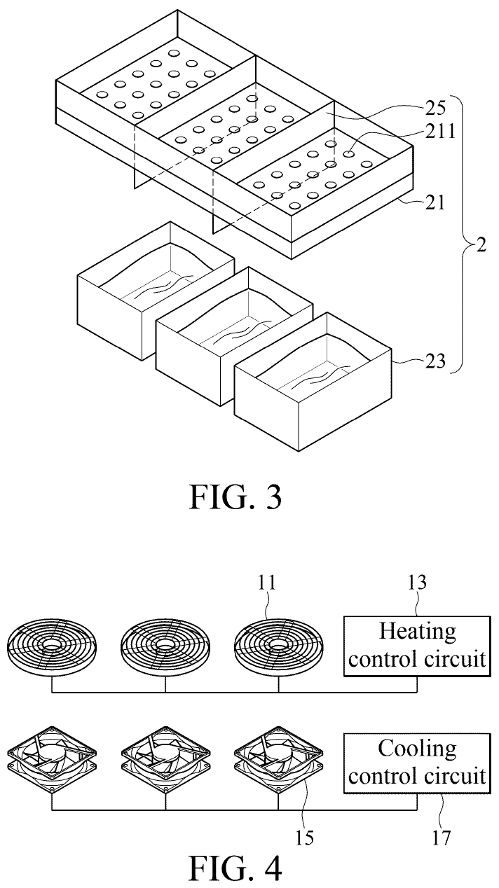

FIG. 3 shows an exploded schematic diagram of a steamer of an embodiment. In this embodiment, the steamer 2 further includes a partition 25. The partition 25 vertically intersects the top ray 21 and is aligned with a boundary between the water tanks 23. Thus, the water vapor from each water tank 23 is directed upward and separated from that of the other water tanks 23. In other words, the water vapor generated from the left water tank 23 is unlikely to travel through the steam holes 211 in the center zone of the top tray 21, as this zone primarily receives vapor from the center water tank 23. This enhances independent temperature control for each zone on the top tray 21.

FIG. 4 shows a schematic diagram of a multi-zone induction cooker of an embodiment. In this embodiment, the multi-zone induction cooker 1 includes a plurality of heating coils 11, a heating control circuit 13, a plurality of cooling fans 15, and a cooling control circuit17. The heating coils 11 are arranged side-by-side. The heating control circuit 13 is electrically coupled to the heating coils 11. The cooling fans 15 are arranged side-by-side and are separated from each other. Each of the cooling fans 15 is disposed beneath each of the heating coils 11.

The cooling control circuit 17 is electrically coupled to the cooling fans 15. The cooling control circuit 17 can respectively regulate a power of each of the cooling fans 15 according to the temperature requests. In one embodiment, the user can use the user control panel 3 to select a desired temperature level, such as high or low, which causes the heating coils 13 and the cooling fans 15 to collaborate in achieving the specified temperature. This allows the user to exercise better control over the temperature, as the cooling fans 15 swiftly dissipate excess heat if the heating coils 13 become overheated.

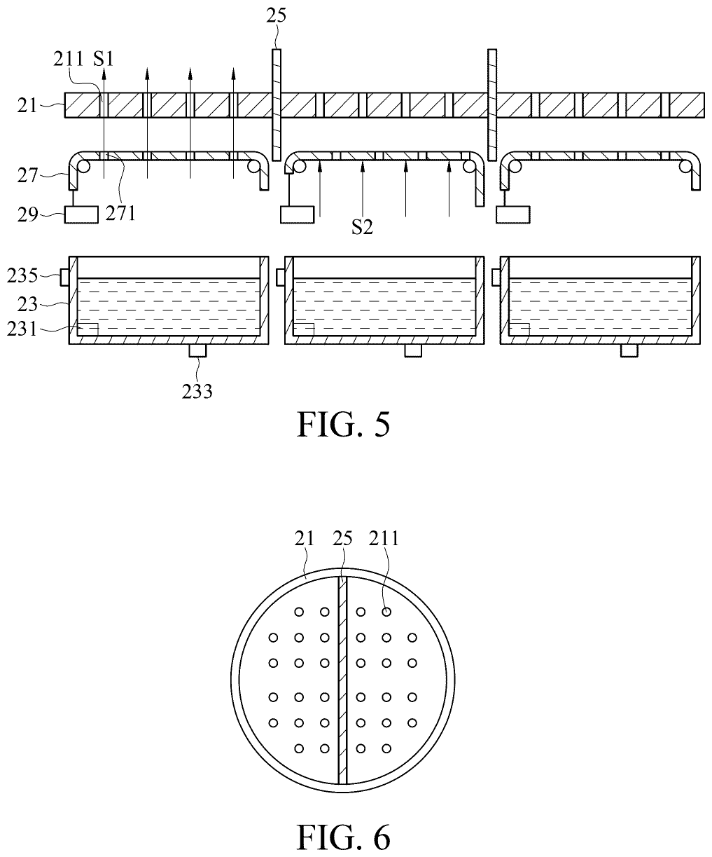

FIG. 5 shows a schematic diagram of a steamer of another embodiment of a food steamer. In the embodiment, the steamer 2 includes a top tray 21, a plurality of water tanks 23, a plurality of partitions 25, a plurality of sliding covers 27 and a plurality of driving devices 29. The top tray 21, water tanks 23, and partitions 25 can be implemented through one or more embodiments of the food steamer mentioned above, thus avoiding redundant repetition of the technical function, results, and advantages.

The plurality of sliding covers 27 is located beneath the top tray 21 and aligned with the water tanks 23 respectively. In one embodiment, the sliding covers 27 are closer to the top tray 21 than to the water tanks 23. The sliding covers 27 are, but not limited to, flexible strips with multiple intermediate holes 271 that can be aligned with the steam holes 211 of the top tray 21 upon request.

The driving devices 29 are connected to the sliding covers 27. The driving devices 29 are electrically coupled to the user control panel 3. Each driving device 29 can drive the corresponding sliding cover 27 when receiving zone requests generated by the user control panel 3. For example, as shown in FIGS. 1 and 5, the left sliding cover 27 opens the steam holes 211 in the left zone of the top tray 21 when the left zone button on the user control panel 3 is selected on. On the other hand, the center sliding cover 27 closes the steam holes 211 in the center zone of the trop tray when the center zone button on the user control panel 3 is selected off. As such, the driving device 29 can control a movement of the sliding cover 27 to selectively open or block the steam holes 211 of the top tray 21 according to the zone requests.

In the embodiment, as shown in FIG. 5, the left sliding cover 27 is in an open position in which the intermediate holes 271 are aligned with the steam holes 211 of the top tray 21. This allows the water vapor S1 from the left water tank 23 to propagate through the steam holes 211 of the top tray 21. On the other hand, the center sliding cover 27 is in a blocking position, with the intermediate holes 271 biased away from the steam holes 211 of the top tray 21. This blocks the water vapor S2 from the center water tank 23 from passing through the top tray 21. As such, the sliding covers 27 enable the food steamer to avoid unnecessary steam evaporation, resulting in water savings.

In one embodiment, the steamer 2 further includes a water level sensor 231. The water level sensor 231 is disposed in each of the water tanks 23. The water level sensor 23 can trigger an alarm when a water level in each of the water tanks 23 is insufficient. For example, the water refill alarm is triggered when the water level in the water tank 23 drops below 1 cm.

FIG. 6 shows a top view of a steamer of yet another embodiment of a food steamer. Please refer to FIGS. 3 and 6 together, which show the top view profile of the food steamer can be varied as a rectangle or circle. In one embodiment shown in FIG. 3, the top view of the top tray 21 is rectangular such that the plurality of the water tanks 23 includes three rectangular pots. In another embodiment shown in FIG. 6, the top view of the top tray 21 is circular such that the plurality of the water tanks includes two semicircular pots.

Referring again to FIG. 5, in one embodiment, each of the water tanks 23 further includes a drain port 233 for draining the water after the use of the food steamer. In addition, each of the water tanks 23 further includes an inlet port 235 for refilling the water into the water tank 23.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

The terms and expressions used herein have the ordinary meaning accorded to such terms and expressions in their respective areas, except where specific meanings have been set forth. Relational terms such as “left,” “center,” and “right” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element proceeded by “a” or “an” does not, without further constraints, preclude the existence of additional elements of the identical type.

What is claimed is:

1. A food steamer comprising:
a multi-zone induction cooker comprising:
a plurality of heating coils arranged side-by-side; and
a heating control circuit electrically coupled to the heating coils;
a steamer disposed on the multi-zone induction cooker and comprising:
a top tray having a plurality of steam holes; and
a plurality of water tanks, each separated from the other and disposed above each of the heating coils; and
a user control panel electrically coupled to the heating control circuit and adapted for generating temperature requests, wherein the heating control circuit can respectively regulate a power of each of the heating coils according to the temperature requests.

2. The food steamer of claim 1, wherein the steamer further comprises a partition that vertically intersects the top ray and is aligned with a boundary between the water tanks.

3. The food steamer of claim 1, wherein the multi-zone induction cooker further comprises:
a plurality of cooling fans, each separated from the other and disposed beneath each of the heating coils; and
a cooling control circuit electrically coupled to the cooling fans and configured to respectively regulate a power of each of the cooling fans according to the temperature requests.

4. The food steamer of claim 1, wherein the steamer further comprises a water level sensor in each of the water tanks and capable of triggering an alarm when a water level in each of the water tanks is insufficient.

5. The food steamer of claim 1, wherein the plurality of the water tanks comprises three rectangular pots.

6. The food steamer of claim 1, wherein the plurality of the water tanks comprises two semicircular pots.

7. The food steamer of claim 1, wherein each of the water tanks further comprises a drain port.

8. The food steamer of claim 1, wherein each of the water tanks further comprises an inlet port.

9. A food steamer comprising:
a multi-zone induction cooker comprising:
a plurality of heating coils arranged side-by-side; and
a heating control circuit electrically coupled to the heating coils;
a steamer disposed on the multi-zone induction cooker and comprising:
a top tray having a plurality of steam holes;
a plurality of water tanks, each separated from the other and disposed above each of the heating coils;
a plurality of sliding covers located beneath the top tray and aligned with the water tanks; and
a plurality of driving devices connected to the sliding covers; and
a user control panel electrically coupled to the heating control circuit and the driving devices, and capable of generating temperature requests and zone requests, wherein the heating control circuit can respectively regulate a power of each of the heating coils according to the temperature requests, and the driving device can control a movement of the sliding cover to selectively open or block the steam holes of the top tray according to the zone requests.

10. The food steamer of claim 9, wherein the steamer further comprises a partition that vertically intersects the top ray and is aligned with a boundary between the water tanks.

11. The food steamer of claim 9, wherein the multi-zone induction cooker further comprises:
a plurality of cooling fans, each separated from the other and disposed beneath each of the heating coils; and
a cooling control circuit electrically coupled to the cooling fans and configured to respectively regulate a power of each of the cooling fans according to the temperature requests.

12. The food steamer of claim 9, wherein the steamer further comprises a water level sensor in each of the water tanks and capable of triggering an alarm when a water level in each of the water tanks is insufficient.

13. The food steamer of claim 9, wherein the plurality of the water tanks comprises three rectangular pots.

14. The food steamer of claim 9, wherein the plurality of the water tanks comprises two semicircular pots.

15. The food steamer of claim 9, wherein each of the water tanks further comprises a drain port.

16. The food steamer of claim 9, wherein each of the water tanks further comprises an inlet port.
